(19) United States
(12) Patent Application Publication
(10) Pub. No.: US 2007/0040964 A1
(43) Pub. Date: Feb. 22, 2007

(54) Liquid crystal display device

(76) Inventors: Kiyoshi Shohara, Saitama-shi (JP); Atsuyuki Manabe, Fukaya-shi (JP); Masumi Manabe, Fukaya-shi (JP); Hiroharu Inoue, Fukaya-shi (JP); Yoshiteru Yamada, Chigasaki-shi (JP); Takeshi Yamamoto, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/504,618

(22) Filed: Aug. 16, 2006

(30) Foreign Application Priority Data
Aug. 19, 2005 (JP) 2005-238861
Jul. 27, 2006 (JP) 2006-205152

(51) Int. Cl. G02F 1/1335

(52) U.S. Cl. 349/106

(57) ABSTRACT

A liquid crystal display device includes an array substrate, a counter-substrate, first pixel sections, second pixel sections, a liquid crystal layer, a color filter including first color layers, which form the first pixel sections, and second color layers which form the second pixel sections, and an undercoat insulation film including first light-transmissive inorganic parts, which form the first pixel sections and are set at such a film thickness that a wavelength at which a transmittance spectrum of the first pixel sections increases agrees with a wavelength at which a transmittance spectrum of the first color layers increases, and second light-transmissive inorganic parts which form the second pixel sections and are set at such a film thickness that a wavelength at which a transmittance spectrum of the second pixel sections increases agrees with a wavelength at which a transmittance spectrum of the second color layers increases.

### CROSS-REFERENCE TO RELATED APPLICATIONS

This application is based upon and claims the benefit of priority from prior Japanese Patent Applications No. 2005-238861, filed Aug. 19, 2005; and No. 2006-205152, filed Jul. 27, 2006, the entire contents of both of which are incorporated herein by reference.

### BACKGROUND OF THE INVENTION

1. Field of the Invention

The present invention relates generally to a liquid crystal display device, and more particularly to a liquid crystal display device comprising a color filter.

2. Description of the Related Art

In general, a liquid crystal display device comprises an array substrate on which thin-film transistors (TFTs) are formed, a counter-substrate which is arranged opposite to the array substrate with a gap therebetween, a liquid crystal layer which is held between the array substrate and the counter-substrate, and a color filter which is provided on the array substrate or the counter-substrate. Further, the liquid crystal display device comprises, for example, a battery and a backlight unit.

The liquid crystal display device has such features as lightness, thinness and low power consumption, and is thus applied to various technical fields of, for instance, office-automation (OA) equipment, information terminals, timepieces, and television receivers. In particular, the liquid crystal display device, which includes thin-film transistors as switching elements, has high responsivity and is used as display units of electronic devices which display a great amount of information, such as cellular telephones, television receivers and computers.

In recent years, there has been a demand for an increase in transmittance of the liquid crystal display device in order to increase the lifetime of a battery for battery-powered use and to reduce power consumption. For this purpose, there have been proposed an increase in aperture ratio by suppressing light-blocking by the TFTs, an increase in transmittance of a color filter, development of low-voltage-driven liquid crystal, and an enhancement of efficiency of a backlight unit. For example, as disclosed in Jpn. Pat. Appln. KOKAI Publication No. 2005-62723, a liquid crystal display device is formed by using a technique in which a color filter is provided on the array substrate in order to increase the aperture ratio.

In the case where the above-described liquid crystal display device is applied to a notebook PC (personal computer) or the like, there has been an additional demand for higher performance, for example, greater resolution and brightness, and a wider viewing angle. It is difficult to obtain a high-performance liquid crystal display device by simply designing a greater aperture ratio, improving the transmittance of the color filter and improving the backlight unit.

### BRIEF SUMMARY OF THE INVENTION

The present invention has been made in consideration of the above-described problem, and the object of the invention is to provide a liquid crystal display device with high transmittance.

In order to achieve the above-described object, according to an aspect of the present invention, there is provided a liquid crystal display device comprising:

an array substrate including a base plate;

a counter-substrate which is arranged opposite to the array substrate with a gap therebetween;

a plurality of first pixel sections and a plurality of second pixel sections, which are provided between the array substrate and the counter-substrate;

a liquid crystal layer which is held between the array substrate and the counter-substrate;

a color filter which is provided on the array substrate and includes a plurality of first color layers, which form the first pixel sections, and a plurality of second color layers which form the second pixel sections and have a color different from a color of the first color layers; and

an undercoat insulation film which is provided on a surface of the base plate and includes a plurality of first light-transmissive inorganic parts, which form the first pixel sections and are set at such a film thickness that a wavelength at which a transmittance spectrum of the first pixel sections increases agrees with a wavelength at which a transmittance spectrum of the first color layers increases, and a plurality of second light-transmissive inorganic parts which form the second pixel sections and are set at such a film thickness that a wavelength at which a transmittance spectrum of the second pixel sections increases agrees with a wavelength at which a transmittance spectrum of the second color layers increases.

According to another aspect of the present invention, there is provided a liquid crystal display device comprising:

an array substrate including a base plate;

a counter-substrate which is arranged opposite to the array substrate with a gap therebetween;

a plurality of first pixel sections and a plurality of second pixel sections, which are provided between the array substrate and the counter-substrate;

a liquid crystal layer which is held between the array substrate and the counter-substrate;

a color filter which is provided on the counter-substrate and includes a plurality of first color layers, which form the first pixel sections, and a plurality of second color layers which form the second pixel sections and have a color different from a color of the first color layers; and

an undercoat insulation film which is provided on a surface of the base plate and includes a plurality of first light-transmissive inorganic parts, which form the first pixel sections and are set at such a film thickness that a wavelength at which a transmittance spectrum of the first pixel sections increases agrees with a wavelength at which a transmittance spectrum of the first color layers increases, and a plurality of second light-transmissive inorganic parts which form the second pixel sections and are set at such a film thickness that a wavelength at which a transmittance spectrum of the second pixel sections increases agrees with a wavelength at which a transmittance spectrum of the second color layers increases.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a liquid crystal display device according to an embodiment of the present invention;

FIG. 2 is a cross-sectional view of the liquid crystal display device shown in FIG. 1, in particular, a liquid crystal display device according to Example 1;

FIG. 3 is a plan view showing, in enlarged scale, a part of an array substrate shown in FIG. 2;

FIG. 4 is a graph showing variations in transmittance, relative to wavelengths of a color filter of the liquid crystal display device;

FIG. 5 is a graph showing variations in transmittance, relative to wavelengths, in the liquid crystal display device according to Example 1;

FIG. 6 is a cross-sectional view of the liquid crystal display device shown in FIG. 1, in particular, a liquid crystal display device according to Example 2;

FIG. 7 is a cross-sectional view of the liquid crystal display device shown in FIG. 1, in particular, a liquid crystal display device according to Example 3;

FIG. 8 is a graph showing variations in transmittance, relative to wavelengths, in the liquid crystal display device according to Example 3; and

FIG. 9 is a table showing variations in luminance level, display quality and reliability of liquid crystal display devices according to Examples 1 to 3 of the invention and Comparative Examples 1 to 5 in cases where the film thickness of light-transmissive inorganic parts is altered.

### DETAILED DESCRIPTION OF THE INVENTION

A liquid crystal display device according to an embodiment of the invention and a manufacturing method of the liquid crystal display device will now be described in detail with reference to the accompanying drawings. To begin with, the structure of a liquid crystal display device, which is manufactured by this manufacturing method, is described.

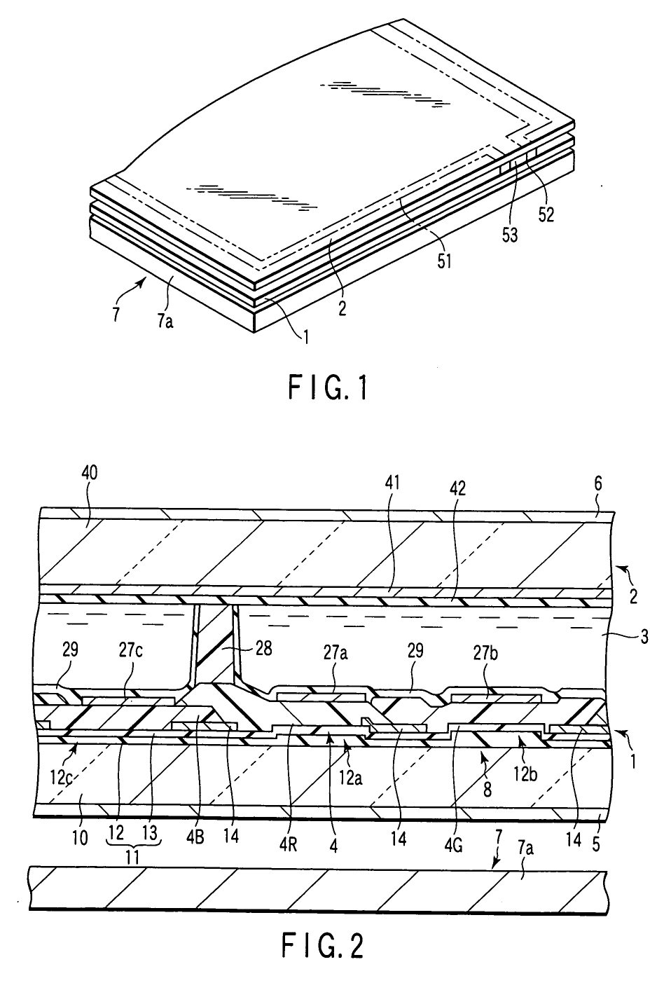

As is shown in FIG. 1 to FIG. 3, the liquid crystal display device comprises an array substrate 1, a counter-substrate 2, a liquid crystal layer 3, a color filter 4, a first polarizer 5, a second polarizer 6, and a backlight unit 7.

The array substrate 1 comprises a glass base plate 10 as a transparent insulating substrate. An undercoat insulation film 11 is formed on the glass base plate 10. The undercoat insulation film 11 includes a first undercoat insulation film 12 and a second undercoat insulation film 13, which are formed on the glass base plate 10 in the named order. In this embodiment, the first undercoat insulation film 12 is formed of an SiN_{X}-based material, and the second undercoat insulation film 13 is formed of an SiO_{X}-based material.

A plurality of stripe-shaped signal lines 20 and a plurality of stripe-shaped scanning lines 21 are formed in a matrix on the undercoat insulation film 11 so as to cross each other. In addition, a plurality of stripe-shaped storage capacitance lines 22, which constitute storage capacitance elements 30, are formed on the undercoat insulation film 11, and the storage capacitance lines 22 extend parallel to the scanning lines 21. A plurality of first pixel sections 18a, a plurality of second pixel sections 18b and a plurality of third pixel sections 18c are formed in regions surrounded by two neighboring signal lines 20 and two neighboring storage capacitance lines 22. The first pixel sections 18a, second pixel sections 18b and third pixel sections 18c are provided between the array substrate 1 and counter-substrate 2.

Thin-film transistors (TFTs) 14, which function as switching elements, are provided near intersections of the signal lines 20 and scanning lines 21. Each TFT 14 includes a semiconductor film 15, which is formed of amorphous silicon (a-Si) or polysilicon (p-Si) as a channel layer, and a gate electrode 17 which is formed of an extension of the scanning line 21. In this embodiment, the semiconductor film 15 and a storage capacitance electrode 16 (to be described later) are formed of p-Si.

To be more specific, semiconductor films 15 and storage capacitance electrodes 16 are formed on the undercoat insulation film 11, and a gate insulation film (not shown) is formed on the undercoat insulation film, semiconductor films and storage capacitance electrodes. The scanning lines 21, gate electrodes 17 and storage capacitance lines 22 are provided on the gate insulation film. The storage capacitance electrode 16 and storage capacitance line 22 are arranged opposite to each other via the gate insulation film. An interlayer insulation film (not shown) is formed on the gate insulation film, scanning lines 21, gate electrodes 17 and storage capacitance lines 22.

The signal lines 20 and contact wiring lines 23 are formed on the interlayer insulation film. The signal lines 20 and contact wiring lines 23 are connected to source regions and drain regions of the semiconductor films 15 via contact holes formed in the gate insulation film and interlayer insulation film. In addition, the contact wiring lines 23 are connected to the storage capacitance electrodes 16 via another contact holes formed in the gate insulation film and interlayer insulation film. The storage capacitance lines 22 are formed over regions from which connection parts between the storage capacitance electrodes 16 and contact wiring lines 23 are excluded.

Red color layers 4R, green color layers 4G and blue color layers 4B are alternately arranged in a neighboring fashion on the TFTs 14, signal lines 20, scanning lines 21 and interlayer insulation film (not shown). In this embodiment, the thickness of each of the color layers 4R, 4G, and 4B is 3.0 μm. Peripheral edge parts of the color layers 4R, 4G and 4B overlap the signal lines 20. The color layers 4R, 4G and 4B constitute the color filter 4. The color filter 4 may be provided on the counter-substrate 2, instead of the array substrate 1. A frame-shaped part (not shown) is formed along the peripheral part of the color filter 4. The frame-shaped part contributes to blocking light which leaks from the peripheral part of the color filter 4.

A plurality of pixel electrodes 27a, 27b and 27c are formed of a transparent electrically conductive material, such as indium tin oxide (ITO), in a matrix on the color layers 4R, 4G and 4B. Each first pixel section 18a is composed of the TFT 14, storage capacitance element 30, color layer 4R and pixel electrode 27a. Each second pixel section 18b is composed of the TFT 14, storage capacitance element 30, color layer 4G and pixel electrode 27b. Each third pixel section 18c is composed of the TFT 14, storage capacitance element 30, color layer 4B and pixel electrode 27c.

Each pixel electrode 27a is connected to the contact wiring line 23 via a contact hole which is formed in the color layer 4R. Each pixel electrode 27b is connected to the contact wiring line 23 via a contact hole which is formed in the color layer 4G. Each pixel electrode 27c is connected to the contact wiring line 23 via a contact hole which is formed in the color layer 4B. Peripheral parts of the pixel electrodes 27a, 27b and 27c overlap the signal lines 20 and storage capacitance lines 22. Thus, the signal lines 20 and storage capacitance lines 22 have a light-blocking function as a black matrix.

A columnar spacer 28 is formed on the color layer 4R. Although not shown entirely, a plurality of columnar spacers 28 are formed on the color filter 4. The columnar spacers 28 may be formed not on the array substrate 1, but on the counter-substrate 2. An alignment film 29 is formed on the color filter 4 and the pixel electrodes 27a, 27b and 27c.

The counter-substrate 2 comprises a glass base plate 40 as a transparent insulating substrate. A common electrode 41 is formed of a transparent electrically conductive material, such as ITO, on the glass base plate 40. An alignment film 42 is formed on the common electrode 41.

The array substrate 1 and counter-substrate 2 are bonded to each other by, e.g., a thermosetting sealing member 51 which is disposed on peripheral parts of both substrates. The array substrate 1 and counter-substrate 2 are arranged opposite to each other with a predetermined gap therebetween by the plural columnar spacers 28. The liquid crystal layer 3 is formed in the space that is surrounded by the array substrate 1, counter-substrate 2 and sealing member 51. A liquid crystal intake 52 is formed in a part of the sealing member 51. The liquid crystal intake 52 is sealed by a sealant 53.

The first polarizer 5 is disposed on the outer surface of the array substrate 1. The second polarizer f6 is disposed on the outer surface of the counter-substrate 2. The liquid crystal display device also includes the backlight unit 7 and a bezel (not shown). The backlight unit 7 includes a light guide 7a, and a light source and a reflection plate (not shown) which are arranged opposite to one side of the light guide 7a. The light guide 7a is arranged opposite to the first polarizer 5.

Detailed structures of the above-described liquid crystal display device, along with manufacturing methods thereof, will be described below.

### EXAMPLE 1

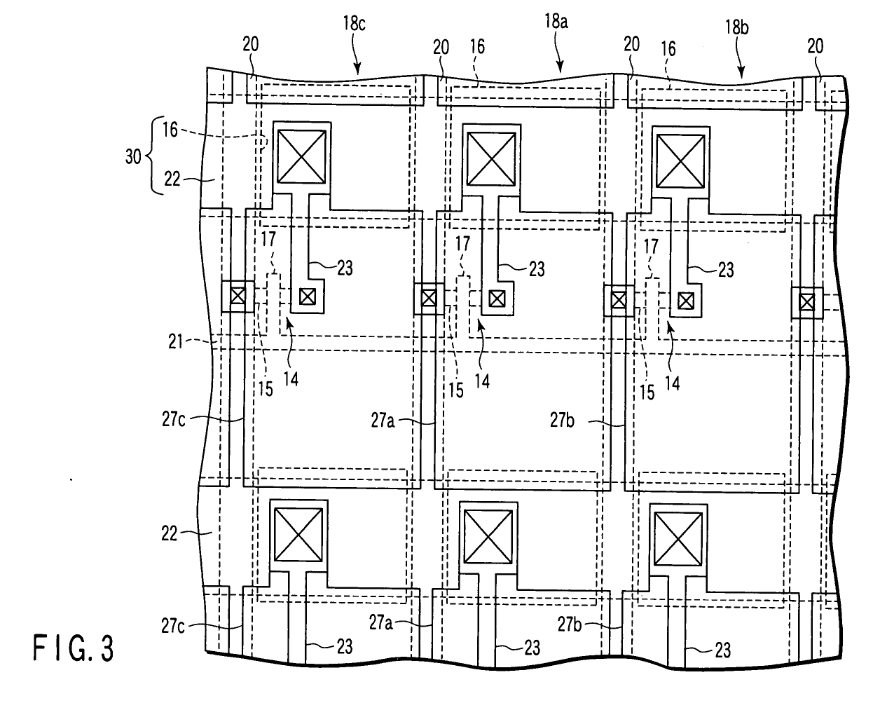

In Example 1, as shown in FIG. 2 and FIG. 3, the color filter 4 is provided on the array substrate 1. The pixel electrodes 27a, 27b and 27c do not form a light-transmissive inorganic part, and each of them has a uniform thickness of 50 nm.

The first undercoat insulation film 12 forms a light-transmissive inorganic part 8. The first undercoat insulation film 12 includes first insulation parts 12a as first light-transmissive inorganic parts, second insulation parts 12b as second light-transmissive inorganic parts, and third insulation parts 12c as third light-transmissive inorganic parts. The first insulation parts 12a, second insulation parts 12b and third insulation parts 12c constitute the respective pixel sections 18.

Each first insulation part 12a overlaps the color layer 4R and has such a film thickness that a wavelength, at which the transmittance spectrum of the first pixel section 18a including the color layer 4R and first insulation part 12a takes a large value, agrees with a wavelength at which the transmittance spectrum of the color layer 4R takes a large value. Each second insulation part 12b overlaps the color layer 4G and has such a film thickness that a wavelength, at which the transmittance spectrum of the second pixel section 18b including the color layer 4G and second insulation part 12b takes a large value, agrees with a wavelength at which the transmittance spectrum of the color layer 4G takes a large value. Each third insulation part 12c overlaps the color layer 4B and has such a film thickness that a wavelength, at which the transmittance spectrum of the third pixel section 18c including the color layer 4B and third insulation part 12c takes a large value, agrees with a wavelength at which the transmittance spectrum of the color layer 4B takes a large value. In Example 1, the film thickness of each first insulation part 12a is set at 160 nm; that of each second insulation part 12b, at 190 nm; and that of each third insulation part 12c, at 150 nm.

Next, a more detailed structure of the above-described liquid crystal display device, along with the manufacturing method of the liquid crystal display device, will be described.

To begin with, a glass base plate 10 is prepared. With the start of the fabrication of the array substrate 1, an undercoat insulation film 11, TFTs 14, an interlayer insulation film, signal lines 20 and scanning lines 21 are formed on the prepared glass base plate 10 by ordinary fabrication steps, such as repeated film formation and patterning.

The fabrication step of the first undercoat insulation film 12 of the undercoat insulation film 11 is described below in detail.

If the fabrication step of the first undercoat insulation film 12 is started, an insulation film with a thickness of 200 nm is formed on the entire surface of the glass base plate 10 by using an SiN_{X}-based insulating material. A positive-type resist is applied on the formed insulation film. Next, a pattern is exposed to the positive-type resist using a predetermined photomask.

At the time of the exposure, an ultraviolet ray having a wavelength of 365 nm is applied to the positive-type resist at an exposure amount of 300 mJ/cm². The photomask has a gradation pattern with different light transmittances corresponding to color layers 4R, 4G and 4B to be overlaid. To be more specific, the photomask includes a first region which passes, with slight light blocking, the light that is applied to the positive-type resist overlapping the area where the pixel electrode 27b is to be formed; a second region which more greatly passes, than the first region, the light that is applied to the positive-type resist overlapping the area where the pixel electrode 27a is to be formed; and a third region which more greatly passes, than the second region, the light that is applied to the positive-type resist overlapping the area where the pixel electrode 27c is to be formed.

After the exposed positive-type resist is developed, the positive-type resist is subjected to post-baking at 120° C. for one hour and a pattern section is formed. Subsequently, oxygen ashing is performed. Thereby, the pattern section of the positive-type resist is removed, and the insulation film is patterned. By using the method in which a photo-engraving process (PEP) and ashing are combined as described above, a plurality of first insulation parts 12a with a film thickness of 160 nm, a plurality of second insulation parts 12b with a film thickness of 190 nm and a plurality of third insulation parts 12c with a film thickness of 150 nm are formed of the patterned insulation film.

Thus, the undercoat insulation film 11 and TFTs 14 are formed on the glass base plate 10.

The manufacturing process then advances to a color filter formation step for forming the color filter 4 on the glass base plate 10. A negative-type ultraviolet-curing acrylic resin resist including, e.g., a dispersed red pigment (hereinafter referred to as “red resist”) is applied as a color layer material on the entire surface of the glass base plate 10 by using a spinner.

Next, a pattern is exposed to the red resist using a predetermined photomask. At the time of the exposure, an ultraviolet ray having a wavelength of 365 nm is applied to the red resist at an exposure amount of 100 mJ/cm². The photomask used here includes stripe-shaped patterns which enable application of ultraviolet on a part that is to be colored in red, and a pattern for contact holes for connection between the pixel electrodes 27a and the TFTs 14.

The exposed red resist is then developed with a 1% aqueous solution of KOH for 20 seconds. Thus, red color layers 4R each having the contact holes and a film thickness of 3.0 μm are formed by the photo-etching process.

Subsequently, like the color layers 4R, green color layers 4G each having a film thickness of 3.0 μm and blue color layers 4B each having a film thickness of 3.0 μm are successively formed in a mutually neighboring fashion by means of the photo-etching process, and contact holes are formed in the color layers. Thus, the color filter 4 is formed on the glass base plate 10.

By using a method in which the PEP and ashing are combined, a plurality of pixel electrodes 27a, a plurality of pixel electrodes 27b and a plurality of pixel electrodes 27c are formed of an electrically conductive film.

After the pixel electrodes 27a, 27b and 27c are formed, a photosensitive acrylic black resist (hereinafter referred to as “black resist”), for example, is applied as a light-blocking material on the glass base plate 10 by means of a spinner. The black resist is dried at 90° C. for 10 minutes.

Next, a photomask is disposed to be opposed to the black resist that is applied on the glass base plate 10. Ultraviolet ray is applied via the photomask, thereby exposing the black resist. At the time of the exposure, ultraviolet ray having a wavelength of 365 nm is applied to the black resist at an exposure amount of 300 mJ/cm². The photomask has a pattern which is opposed to regions where columnar spacers 28 and the above-mentioned frame-shaped part are to be formed.

Subsequently, the exposed black resist is developed with an alkali aqueous solution having a pH 11.5, and the developed black resist is baked at 200° C. for 60 minutes. Thereby, a plurality of columnar spacers 28 each having a height of 5 μm and the frame-shaped part are formed of the same material at the same time.

Then, an alignment film material with a thickness of 100 nm is applied to the entire surface of the glass base plate 10, and an alignment film 29 is formed. The alignment film 29 is subjected to predetermined alignment film treatment (rubbing). Thereby, the fabrication of the array substrate 1 is completed.

On the other hand, as regards the fabrication of the counter-substrate 2, a glass base plate 40 is first prepared. An ITO film with a thickness of 200 nm is formed on the glass base plate 40, and thus a common electrode 41 is formed. Then, an alignment film material with a thickness of 100 nm is applied to the entire surface of the glass base plate 40, and thus an alignment film 42 is formed.

After a seal material of, e.g. a thermosetting type is printed along peripheral edges of the alignment film 42 of the counter-substrate 2, transfer materials which conduct common electrode and transfer electrode that supply common voltage from an array substrate electrode to common electrode are formed in the vicinity of the seal member 51. Then, the array substrate 1 and counter-substrate 2 are arranged opposite to each other with a predetermined gap therebetween by the columnar spacers 28, and the peripheral parts of the array substrate 1 and counter-substrate 2 are attached by the seal member 51. The array substrate 1 and counter-substrate 2 are opposed such that the directions of rubbing of their alignment films 29 and 42 are perpendicular to each other. Thereafter, the seal member 51 is heated and cured to fix the array substrate 1 and counter-substrate 2.

A liquid crystal with a positive dielectric anisotropy is injected from a liquid crystal intake 52 that is formed in a part of the sealing member 51. The liquid crystal intake 52 is then sealed by a sealant 53 that is formed of, e.g., an ultraviolet-curing resin. Thus, the liquid crystal is sealed between the array substrate 1 and counter-substrate 2, and a liquid crystal layer 3 having a thickness of 5 μm is formed. Then, a first polarizer 5 is attached to the outer surface of the array substrate 1, and a second polarizer 6 is attached to the outer surface of the counter-substrate 2. Further, a backlight unit and a bezel (not shown) are attached, and a module is assembled. Thereby, the liquid crystal display device, as shown in FIG. 2, is completely manufactured.

Next, spectrum characteristics of red, green and blue lights which have passed through the color filter 4 are explained.

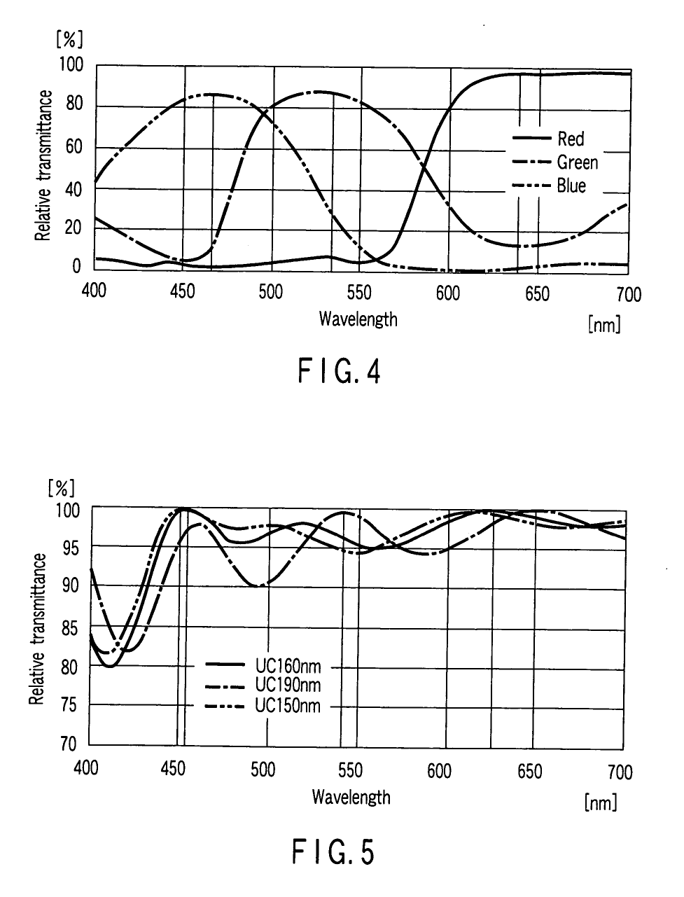

As shown in FIG. 4, the transmittance spectrum of red light of each color layer 4R takes an almost peak value at a wavelength of 640 nm, and thus becomes large near the wavelength of 640 nm. The transmittance spectrum of green light of each color layer 4G takes an almost peak value at a wavelength of 535 nm, and thus becomes large near the wavelength of 535 nm. The transmittance spectrum of blue light of each color layer 4B takes an almost peak value at a wavelength of 465 nm, and thus becomes large near the wavelength of 465 nm.

The spectrum characteristics of the light, which has passed through the first undercoat insulation film (UC) 12, will be explained below.

As shown in FIG. 5, it can be seen that the wavelengths, at which the transmittance spectra of the first insulation parts 12a, second insulation parts 12b and third insulation parts 12c that are formed of the SiN_{X}-based material take large values, vary depending on the thicknesses of the first to third insulation parts 12a to 12c. The reason is that interference waves of spectra corresponding to the thicknesses of the first to third insulation parts 12a to 12c occur in the light that has passed through the first to third insulation parts 12a to 12c.

According to the study by the inventors of the present invention, one of the wavelengths, at which the transmittance spectrum of each first pixel section 18a including the first insulation part 12a with the thickness of 160 nm increases, is 630 nm. It can be seen that this wavelength agrees with the wavelength at which the transmittance spectrum of each color layer 4R overlapping the first insulation part 12a increases.

One of the wavelengths, at which the transmittance spectrum of each second pixel section 18b including the second insulation part 12b with the thickness of 190 nm increases, is 540 nm. It can be seen that this wavelength agrees with the wavelength at which the transmittance spectrum of each color layer 4G overlapping the second insulation part 12b increases.

One of the wavelengths, at which the transmittance spectrum of each third pixel section 18c including the third insulation part 12c with the thickness of 150 nm increases, is 460 nm. It can be seen that this wavelength agrees with the wavelength at which the transmittance spectrum of each color layer 4B overlapping the third insulation part 12c increases.

By making the wavelengths agree with each other as described above, the transmittance of each pixel section can be enhanced, and accordingly the transmittance of the entire display device can be enhanced.

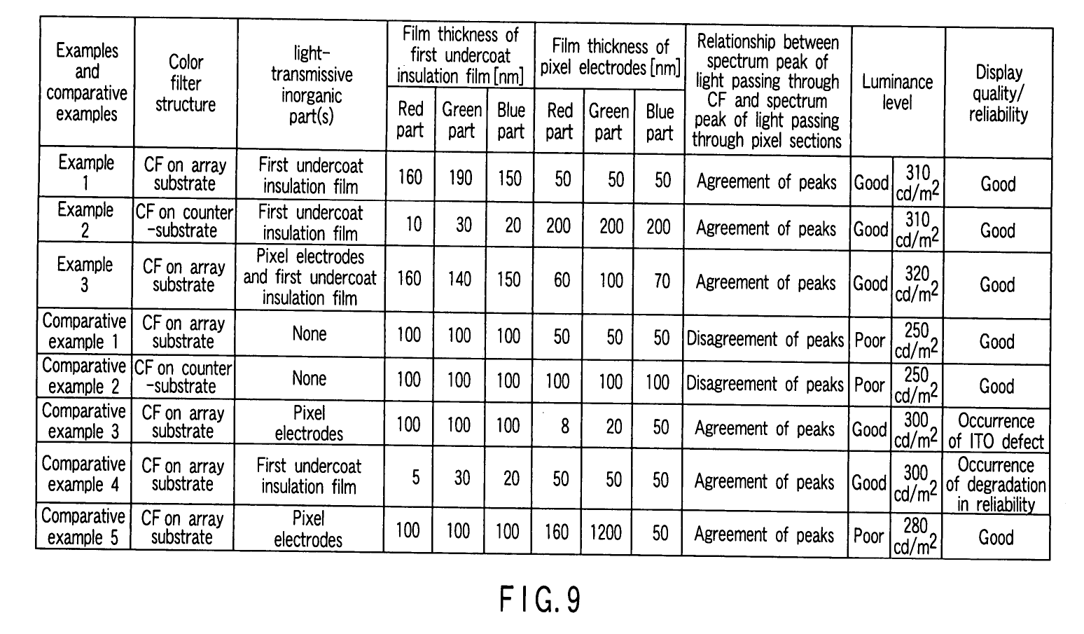

As shown in FIG. 9, an image is displayed by the liquid crystal display device, which is completely manufactured in Example 1, by turning on the backlight. Non-uniformity in display was not observed, and the display uniformity was good. The peaks of the chromatic spectra of the respective pixel sections were made to agree with the peaks of the interference spectra of the first insulation parts 12a, second insulation parts 12b and third insulation parts 12c. Thereby, the peaks of the chromatic spectra of the color layers 4R, 4G and 4B agreed with the peaks of the transmittance spectra of the pixel sections from which the color layers are excluded, and a high luminance of 310 cd/m² was obtained.

A reliability test was conducted by continuously turning on the completed liquid crystal display device for 500 hours in an environment at a high temperature (50° C.) and high humidity (80%). No deterioration in display was observed, a good display quality was obtained, and it was confirmed that the liquid crystal display device was highly reliable.

### EXAMPLE 2

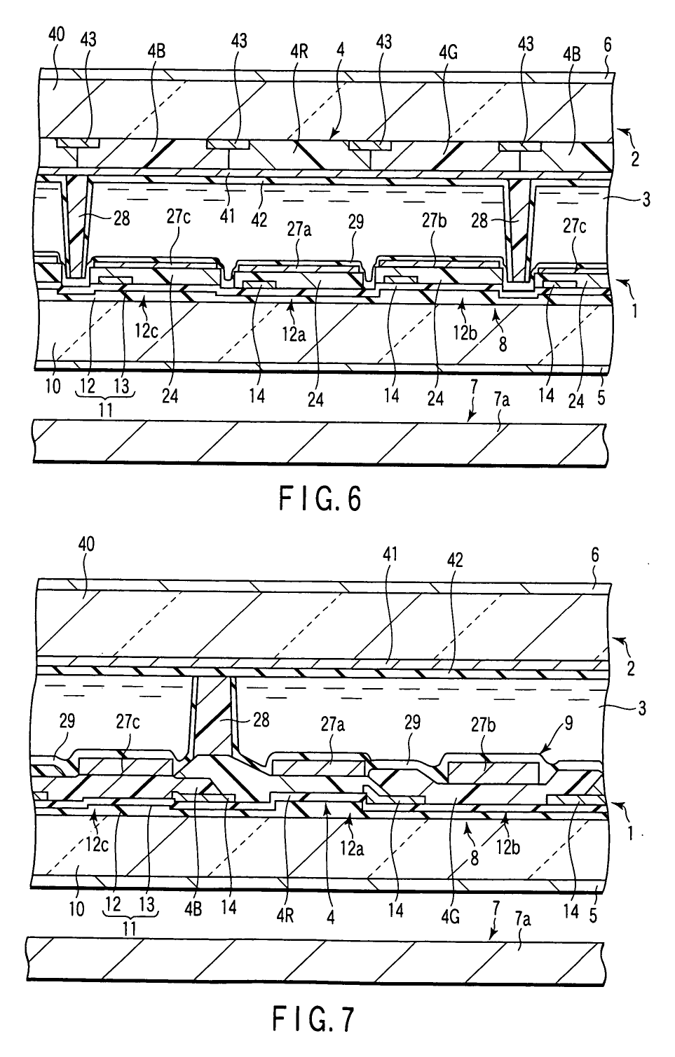

In Example 2, as shown in FIG. 6, the color filter 4 is provided on the counter-substrate 2. The pixel electrodes 27a, 27b and 27c do not form a light-transmissive inorganic part 8, and each of the pixel electrodes 27a, 27b and 27c has a uniform thickness of 200 nm.

The first undercoat insulation film 12, as in Example 1, forms a light-transmissive inorganic part 8. The first undercoat insulation film 12 includes first insulation parts 12a, second insulation parts 12b and third insulation parts 12c. In Example 2, the film thickness of each first insulation part 12a is set at 10 nm, that of each second insulation part 12b, at 30 nm, and that of each third insulation part 12c, at 20 nm.

A plurality of transparent insulation resist parts 24 each having a film thickness of 3 μm are provided in a matrix on the glass base plate 10 on which the TFTs 14, signal lines 20, scanning lines 21 and interlayer insulation film (not shown) are formed. The transparent insulation resist parts 24 are provided in the first pixel sections 18a, second pixel sections 18b and third pixel sections 18c.

A plurality of pixel electrodes 27a, 27b and 27c are formed of ITO, which is a transparent electrically conductive material, on the plural transparent insulation resist parts 24. As in Example 1, the pixel electrodes 27a, 27b and 27c are formed by the method in which the PEP and ashing are combined.

As is shown in FIG. 9, according to the study by the inventors of the present invention, it can be seen that one of the wavelengths, at which the transmittance spectrum of each first pixel section 18a including the first insulation part 12a with the thickness of 10 nm increases, agrees with the wavelength at which the transmittance spectrum of each color layer 4R overlapping the first insulation part 12a increases.

It can be seen that one of the wavelengths, at which the transmittance spectrum of each second pixel section 18b including the second insulation part 12b with the thickness of 30 nm increases, agrees with the wavelength at which the transmittance spectrum of each color layer 4G overlapping the second insulation part 12b increases.

It can be seen that one of the wavelengths, at which the transmittance spectrum of each third pixel section 18c including the third insulation part 12c with the thickness of 20 nm increases, agrees with the wavelength at which the transmittance spectrum of each color layer 4B overlapping the third insulation part 12c increases.

By making the wavelengths agree with each other as described above, the transmittance of each pixel section can be enhanced, and accordingly the transmittance of the entire display device can be enhanced.

When the first undercoat insulation film 12 is to be formed, an insulation film with a thickness of 50 nm is formed on the entire surface of the glass base plate 10 by using an SiN_{X}-based insulating material. As in Example 1, a plurality of first insulation parts 12a, a plurality of second insulation parts 12b and a plurality of third insulation parts 12c are formed by the method in which the PEP and ashing are combined.

An alignment film 29 with a thickness of 100 nm is formed on the glass base plate 10 on which the pixel electrodes 27a, 27b and 27c are formed.

In the counter-substrate 2, a black-matrix layer 43 is formed on the glass base plate 40. Color layers 4R, 4G and 4B are alternately arranged on the glass base plate 40 and black-matrix layer 43, thus forming the color filter 4. The color layers 4R, 4G and 4B are formed in stripe shapes, and the peripheral edge parts of the color layers 4R, 4G and 4B are overlapped with the black-matrix layer 43.

A common electrode 41 with a thickness of 200 nm is formed of ITO, which is a transparent electrically conductive material, on the color layers 4R, 4G and 4B. A plurality of columnar spacers 28 are formed on the common electrode 41. An alignment film 42 with a thickness of 100 nm is formed on the glass base plate 40 on which the common electrode 41 and columnar spacers 28 are formed. A liquid crystal display device is completely fabricated by assembling a module using the array substrate 1 and counter-substrate 2, as in Example 1.

As shown in FIG. 9, an image is displayed by the liquid crystal display device, which is completely manufactured in Example 2, by turning on the backlight. Non-uniformity in display was not observed, and the display uniformity was good. The peaks of the chromatic spectra of the respective pixel sections were made to agree with the peaks of the interference spectra of the first insulation parts 12a, second insulation parts 12b and third insulation parts 12c. Thereby, the peaks of the chromatic spectra of the color layers 4R, 4G and 4B agreed with the peaks of the transmittance spectra of the pixel sections from which the color layers are excluded, and a high luminance of 310 cd/m² was obtained.

A reliability test was conducted by continuously turning on the completed liquid crystal display device for 500 hours in an environment at a high temperature (50° C.) and high humidity (80%). No deterioration in display was observed, a good display quality was obtained, and it was confirmed that the liquid crystal display device was highly reliable.

### EXAMPLE 3

As is shown in FIG. 7, in Example 3, like Example 1, the color filter 4 is provided on the array substrate 1. The first undercoat insulation film 12 forms a light-transmissive inorganic part 8, and includes first insulation parts 12a, second insulation parts 12b and third insulation parts 12c. Each first insulation part 12a forms a first light-transmissive inorganic part, each second insulation part 12b forms a second light-transmissive inorganic part, and each third insulation part 12c forms a third light-transmissive inorganic part.

The pixel electrodes 27a, 27b and 27c form other light-transmissive inorganic parts 9. Each pixel electrode 27a forms another first light-transmissive inorganic part, each pixel electrode 27b forms another second light-transmissive inorganic part, and each pixel electrode 27c forms another third light-transmissive inorganic part. Each first insulation part 12a and each pixel electrode 27a form the first pixel section 18a. Each second insulation part 12b and each pixel electrode 27b form the second pixel section 18b. Each third insulation part 12c and each pixel electrode 27c form the third pixel section 18c.

Each first insulation part 12a overlaps the color layer 4R and has such a film thickness that a wavelength, at which the transmittance spectrum of each first pixel section 18a including the color layer 4R and first insulation part 12a takes a large value, agrees with a wavelength at which the transmittance spectrum of the color layer 4R takes a large value. Each second insulation part 12b overlaps the color layer 4G and has such a film thickness that a wavelength, at which the transmittance spectrum of each second pixel section 18b including the color layer 4G and second insulation part 12b takes a large value, agrees with a wavelength at which the transmittance spectrum of the color layer 4G takes a large value.

Each third insulation part 12c overlaps the color layer 4B and has such a film thickness that a wavelength, at which the transmittance spectrum of each third pixel section 18c including the color layer 4B and third insulation part 12c takes a large value, agrees with a wavelength at which the transmittance spectrum of the color layer 4B takes a large value. In Example 3, the film thickness of each first insulation part 12a is set at 160 nm; that of each second insulation part 12b, at 140 nm; and that of each third insulation part 12c, at 150 nm.

Each pixel electrode 27a overlaps the color layer 4R and has such a film thickness that a wavelength, at which the transmittance spectrum of each first pixel section 18a including the color layer 4R and pixel electrode 27a takes a large value, agrees with a wavelength at which the transmittance spectrum of the color layer 4R takes a large value.

Each pixel electrode 27b overlaps the color layer 4G and has such a film thickness that a wavelength, at which the transmittance spectrum of each second pixel section 18b including the color layer 4G and pixel electrode 27b takes a large value, agrees with a wavelength at which the transmittance spectrum of the color layer 4G takes a large value.

Each pixel electrode 27c overlaps the color layer 4B and has such a film thickness that a wavelength, at which the transmittance spectrum of the third pixel section 18c including the color layer 4B and pixel electrode 27c takes a large value, agrees with a wavelength at which the transmittance spectrum of the color layer 4B takes a large value. In Example 3, the film thickness of each pixel electrode 27a is set at 60 nm; that of each pixel electrode 27b, at 100 nm, and that of each pixel electrode 27c, at 70 nm.

Like the above-described Example, the first undercoat insulation film 12 and the pixel electrodes 27a, 27b and 27c are formed by the method in which the PEP and ashing are combined.

Next, a method of fabricating the pixel electrodes 27a, 27b and 27c is described in detail. A film of ITO with a thickness of 200 nm is deposited by sputtering on the entire surface of the glass base plate 10 and color layers 4R, 4G and 4B. Thereby, an electrically conductive film with a thickness of 200 nm is formed on the glass base plate 10.

Subsequently, a positive-type resist with a film thickness of 1.5 μm is applied to the electrically conductive film, and the applied positive-type resist is dried. Thereby, a positive-type resist is formed on the electrically conductive film. Then, a pattern is exposed to the positive-type resist using a predetermined photomask.

At the time of the exposure, an ultraviolet ray having a wavelength of 365 nm is applied to the positive-type resist at an exposure amount of 300 mJ/cm². The photomask has a gradation pattern with different light transmittances corresponding to color layers 4R, 4G and 4B to be overlaid.

After the exposed positive-type resist is developed, the developed positive-type resist is subjected to post-baking at 120° C. for one hour. Thereby, second pattern sections 62 each having a greatest film thickness, third pattern sections each having a smaller film thickness than the second pattern sections and first pattern sections each having a smallest film thickness are formed on the electrically conductive film.

The electrically conductive film is etched by using oxalic acid, and then oxygen ashing is performed. Thereby, the first pattern sections 61, second pattern sections 62 and third pattern sections 63 are removed, and the electrically conductive film is patterned. By using the method in which the PEP and the ashing are combined as described above, a plurality of pixel electrodes 27a overlapping the color layers 4R and having a film thickness of 60 nm, a plurality of pixel electrodes 27b overlapping the color layers 4G and having a film thickness of 100 nm and a plurality of pixel electrodes 27c overlapping the color layers 4B and having a film thickness of 70 nm are formed of the patterned electrically conductive film.

The spectrum characteristics of the light, which has passed through the first undercoat insulation film (UC) 12 and pixel electrodes 27a, 27b and 27c, will be explained below.

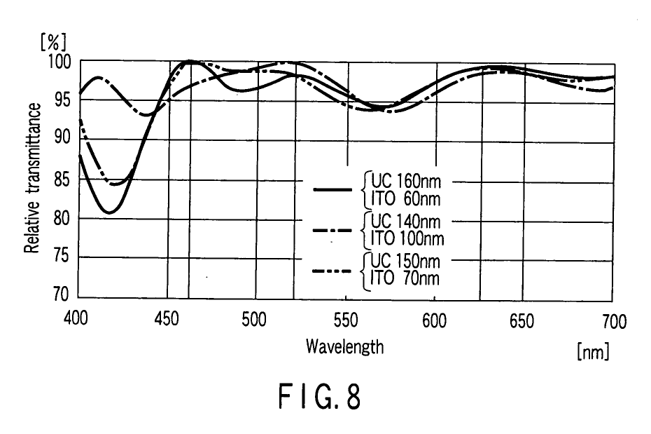

As is shown in FIG. 8, according to the study by the inventors of the present invention, it can be seen that one of the wavelengths, at which the transmittance spectrum of each first pixel section 18a including the first insulation part 12a with the thickness of 160 nm and the pixel electrode 27a with the thickness of 60 nm increases, is 630 nm and agrees with the wavelength at which the transmittance spectrum of each color layer 4R overlapping the first insulation part 12a and pixel electrode 27a increases.

It can be seen that one of the wavelengths, at which the transmittance spectrum of each second pixel section 18b including the second insulation part 12b with the thickness of 140 nm and the pixel electrode 27b with the thickness of 100 nm increases, is 520 nm and agrees with the wavelength at which the transmittance spectrum of each color layer 4G overlapping the second insulation part 12b and pixel electrode 27b increases.

It can be seen that one of the wavelengths, at which the transmittance spectrum of each third pixel section 18c including the third insulation part 12c with the thickness of 150 nm and the pixel electrode 27c with the thickness of 70 nm increases, is 465 nm and agrees with the wavelength at which the transmittance spectrum of each color layer 4B overlapping the third insulation part 12c and pixel electrode 27c increases.

By making the wavelengths agree with each other as described above, the transmittance of each pixel section can be enhanced, and accordingly the transmittance of the entire display device can be enhanced.

As shown in FIG. 9, an image is displayed by the liquid crystal display device, which is completely manufactured in Example 3, by turning on the backlight. Non-uniformity in display was not observed, and the display uniformity was good. The peaks of the chromatic spectra of the respective pixel sections were made to agree with the peaks of the interference spectra of the first insulation parts 12a, second insulation parts 12b and third insulation parts 12c. Further, the peaks of the chromatic spectra of the respective pixel sections were made to agree with the peaks of the interference spectra of the pixel electrodes 27a, 27b and 27c. Thereby, the peaks of the chromatic spectra of the color layers 4R, 4G and 4B agreed with the peaks of the transmittance spectra of the pixel sections from which the color layers are excluded, and a high luminance of 320 cd/m² was obtained.

A reliability test was conducted by continuously turning on the completed liquid crystal display device for 500 hours in an environment at a high temperature (50° C.) and high humidity (80%). No deterioration in display was observed, a good display quality was obtained, and it was confirmed that the liquid crystal display device was highly reliable. In Examples 2 and 3, the other structure is the same as that of Example 1. Common parts are denoted by like reference numerals, and a detailed description is omitted.

Next, a description is given of Comparative Examples 1 to 5 in which the transmittance of the liquid crystal display decreases or the reliability deteriorates. In Comparative Examples 1 to 5, the structural parts common to those of the above-described Examples are denoted by like reference numerals, and a detailed description is omitted.

### COMPARATIVE EXAMPLE 1

In Comparative Example 1, the color filter 4 is provided on the array substrate 1. The first undercoat insulation film 12 does not form a light-transmissive inorganic part, and has a uniform thickness of 100 nm. The pixel electrodes 27a, 27b and 27c do not form a light-transmissive inorganic part, and each of them has a uniform thickness of 50 nm.

As shown in FIG. 9, an image is displayed by the liquid crystal display device, which is completely. manufactured in Comparative Example 1, by turning on the backlight. Non-uniformity in display was not observed, and the display uniformity was good. The peaks of the chromatic spectra of the color layers 4R, 4G and 4B failed to agree with the peaks of the transmittance spectra of the pixel sections from which the color layers are excluded, and only a low luminance of 250 cd/m² was obtained.

A reliability test was conducted by continuously turning on the completed liquid crystal display device for 500 hours in an environment at a high temperature (50° C.) and high humidity (80%). No deterioration in display was observed, a good display quality was obtained, and it was confirmed that the liquid crystal display device was highly reliable.

### COMPARATIVE EXAMPLE 2

In Comparative Example 2, the color filter 4 is provided on the counter-substrate 2. The first undercoat insulation film 12 does not form a light-transmissive inorganic part, and has a uniform thickness of 100 nm. The pixel electrodes 27a, 27b and 27c do not form a light-transmissive inorganic part, and each of them has a uniform thickness of 100 nm.

As shown in FIG. 9, an image is displayed by the liquid crystal display device, which is completely manufactured in Comparative Example 2, by turning on the backlight. Non-uniformity in display was not observed, and the display uniformity was good. The peaks of the chromatic spectra of the color layers 4R, 4G and 4B failed to agree with the peaks of the transmittance spectra of the pixel sections from which the color layers are excluded, and only a low luminance of 250 cd/m² was obtained.

A reliability test was conducted by continuously turning on the completed liquid crystal display device for 500 hours in an environment at a high temperature (50° C.) and high humidity (80%). No deterioration in display was observed, a good display quality was obtained, and it was confirmed that the liquid crystal display device was highly reliable.

### COMPARATIVE EXAMPLE 3

In Comparative Example 3, the color filter 4 is provided on the array substrate 1. The first undercoat insulation film 12 does not form a light-transmissive inorganic part, and has a uniform thickness of 100 nm. The pixel electrodes 27a, 27b and 27c form light-transmissive inorganic parts 8. Like the above-described Example, the pixel electrodes 27a, 27b and 27c are formed by the method in which the PEP and ashing are combined. The thickness of each pixel electrode 27a is 8 nm; that of each pixel electrode 27b, 20 nm; and that of each pixel electrode 27c, 50 nm.

According to the study by the inventors of the present invention, it can be seen that the wavelength, at which the transmittance spectrum of each first pixel section 18a including the pixel electrode 27a with the thickness of 8 nm increases, agrees with the wavelength at which the transmittance spectrum of each color layer 4R provided in the same pixel section as the pixel electrode 27a increases. It can be seen that the wavelength, at which the transmittance spectrum of each second pixel section 18b including the pixel electrode 27b with the thickness of 20 nm increases, agrees with the wavelength at which the transmittance spectrum of each color layer 4G provided in the same pixel section as the pixel electrode 27b increases. It can be seen that the wavelength, at which the transmittance spectrum of each third pixel section 18c including the pixel electrode 27c with the thickness of 50 nm increases, agrees with the wavelength at which the transmittance spectrum of each color layer 4B provided in the same pixel section as the pixel electrode 27c increases.

As shown in FIG. 9, an image is displayed by the liquid crystal display device, which is completely manufactured in Comparative Example 3, by turning on the backlight. The peaks of the chromatic spectra of the color layers 4R, 4G and 4B agreed with the peaks of the transmittance spectra of the pixel sections from which the color layers are excluded, and a high luminance of 300 cd/m² was obtained.

However, a defect occurred in electrical conductivity due to an inadequate film thickness of each pixel electrode 27a, and a line-shaped defect occurred on the display screen

### COMPARATIVE EXAMPLE 4

In Comparative Example 4, the color filter 4 is provided on the array substrate 1. The pixel electrodes 27a, 27b and 27c do not form a light-transmissive inorganic part, and each of the pixel electrodes 27a, 27b and 27c has a uniform thickness of 50 nm. Like the above-described Example 1, etc., the first undercoat insulation film 12 forms a light-transmissive inorganic part 8, and includes first insulation parts 12a, second insulation parts 12b and third insulation parts 12c.

As in the above-described Example, the first insulation parts 12a, second insulation parts 12b and third insulation parts 12c are formed by the method in which the PEP and ashing are combined. The film thickness of each first insulation part 12a is set at 5 nm; that of each second insulation part 12b, at 30 nm, and that of each third insulation part 12c, at 20 nm.

According to the study by the inventors of the present invention, it can be seen that the wavelength, at which the transmittance spectrum of each first pixel section 18a including the first insulation part 12a with the thickness of 5 nm increases, agrees with the wavelength at which the transmittance spectrum of each color layer 4R provided in the same pixel section as the first insulation part 12a increases. It can be seen that the wavelength, at which the transmittance spectrum of each second pixel section 18b including the second insulation part 12b with the thickness of 20 nm increases, agrees with the wavelength at which the transmittance spectrum of each color layer 4G provided in the same pixel section as the second insulation part 12b increases. It can be seen that the wavelength, at which the transmittance spectrum of each third pixel section 18c including the third insulation part 12c with the thickness of 50 nm increases, agrees with the wavelength at which the transmittance spectrum of each color layer 4B provided in the same pixel section as the third insulation part 12c increases.

As shown in FIG. 9, an image is displayed by the liquid crystal display device, which is completely manufactured in Comparative Example 4, by turning on the backlight. The peaks of the chromatic spectra of the color layers 4R, 4G and 4B agreed with the peaks of the transmittance spectra of the pixel sections from which the color layers are excluded, and a high luminance of 300 cd/m² was obtained.

However, when a reliability test was conducted by continuously turning on the completed liquid crystal display device for 500 hours in an environment at a high temperature (50° C.) and high humidity (80%), it was found that degradation occurred in TFT characteristics due to impurity blocking properties because of an inadequate film thickness of the first insulation part 12a, leading to deterioration in display quality.

### COMPARATIVE EXAMPLE 5

In Comparative Example 5, the color filter 4 is provided on the array substrate 1. The first undercoat insulation film 12 does not form a light-transmissive inorganic part, and has a uniform thickness of 100 nm. The pixel electrodes 27a, 27b and 27c form light-transmissive inorganic parts 8. Like the above-described Example, the pixel electrodes 27a, 27b and 27c are formed of the electrically conductive film with a thickness of 1500 nm by the method in which the PEP and ashing are combined. The film thickness of each pixel electrode 27a is 160 nm, the film thickness of each pixel electrode 27b is 1200 nm, and the film thickness of each pixel electrode 27c is 50 nm.

According to the study by the inventors of the present invention, it can be seen that the wavelength, at which the transmittance spectrum of each first pixel section 18a including the pixel electrode 27a with the thickness of 160 nm increases, agrees with the wavelength at which the transmittance spectrum of each color layer 4R provided in the same pixel section as the pixel electrode 27a increases. It can be seen that the wavelength, at which the transmittance spectrum of each second pixel section 18b including the pixel electrode 27b with the thickness of 1200 nm increases, agrees with the wavelength at which the transmittance spectrum of each color layer 4G provided in the same pixel section as the pixel electrode 27b increases. It can be seen that the wavelength, at which the transmittance spectrum of each third pixel section 18c including the pixel electrode 27c with the thickness of 50 nm increases, agrees with the wavelength at which the transmittance spectrum of each color layer 4B provided in the same pixel section as the pixel electrode 27c increases.

As shown in FIG. 9, an image is displayed by the liquid crystal display device, which is completely manufactured in Comparative Example 5, by turning on the backlight. The peaks of the chromatic spectra of the color layers 4R, 4G and 4B agreed with the peaks of the transmittance spectra of the pixel sections from which the color layers are excluded. However, degradation occurred in the optical transparency, i.e. the transmittance, of the pixel electrode 27b, and only a low luminance of 280 cd/m² was obtained.

The liquid crystal display device having the above-described structure includes the pixel electrodes 27a, 27b and 27c as the light-transmissive inorganic parts 8, or includes the first undercoat insulation film 12 as the light-transmissive inorganic part 8, or includes the first undercoat insulation film 12 as the light-transmissive inorganic part 8 and the pixel electrodes 27a, 27b and 27c as other light-transmissive inorganic parts 9.

The pixel electrodes 27a, 27b and 27c functioning as the light-transmissive inorganic parts 8 have such film thicknesses that the wavelengths, at which the transmittance spectra of the first to third pixel sections 18a, 18b and 18c including the color layers 4R, 4G and 4B take large values, agree with the wavelengths at which the transmittance spectra of the color layers 4R, 4G and 4B take large values. The first undercoat insulation film 12 functioning as the light-transmissive inorganic parts 8 has such a film thickness that the wavelengths, at which the transmittance spectra of the pixel sections 18 including the color layers 4R, 4G and 4B take large values, agree with the wavelengths at which the transmittance spectra of the color layers 4R, 4G and 4B take large values.

The first undercoat insulation film 12 functioning as the light-transmissive inorganic parts 8 and the pixel electrodes 27a, 27b and 27c functioning as the other light-transmissive inorganic parts 9 have such film thicknesses that the wavelengths, at which the transmittance spectra of the first to third pixel sections 18a, 18b and 18c including the color layers 4R, 4G and 4B take large values, agree with the wavelengths at which the transmittance spectra of the color layers 4R, 4G and 4B take large values. Thereby, the wavelengths, at which the transmittance spectra of the color layers 4R, 4G and 4B increase, agree with the wavelengths at which the transmittance spectra of the first to third pixel sections 18a, 18b and 18c increase.

Thus, the liquid crystal display device with high transmittance can be obtained, and the liquid crystal display device with high luminance, which has not been achieved by the improvements in aperture ratio, transmittance of color filters and backlight, can be obtained. With the liquid crystal display device having high transmittance, the power consumption can be reduced and a long-time use with the battery built in the liquid crystal display device is realized.

The light-transmissive inorganic parts 8 (or other light-transmissive inorganic parts 9) are formed of the first undercoat insulation film 12 or pixel electrodes 27a, 27b and 27c. The first undercoat insulation film 12 needs to have sufficient insulation performance, the pixel electrodes 27a, 27b and 27c need to have sufficient electrical conductivity, and both need to have a blocking performance for blocking inorganic impurities such as Na and K, and organic impurities such as amines and carboxylic acid. From the standpoint of these performances and product reliability, the first undercoat insulation film 12 and pixel electrodes 27a, 27b and 27c need to have a film thickness of 10 nm or more as a practical value.

If the thickness of the first undercoat insulation film 12 and pixel electrodes 27a, 27b and 27c becomes too large, the transmittance would decrease. In practical terms, if the film thickness exceeds 1000 nm, the light transmittance would considerably deteriorate. Taking the above effects into account, the film thicknesses of the first to third insulation parts 12a, 12b and 12c and pixel electrodes 27a, 27b and 27c as the light-transmissive inorganic parts should preferably be 10 to 1000 nm.

Even if the film thicknesses of the first to third insulation parts 12a, 12b and 12c and pixel electrodes 27a, 27b and 27c are varied, the uniformity in display characteristics and the reliability are not adversely affected. Thus, the liquid crystal display device with excellent display quality and high reliability can be obtained.

In the case where the first undercoat insulation film 12 and pixel electrodes 27a, 27b and 27c are to be formed with desired thicknesses, these components can be formed to have desired thicknesses if film formation and patterning are repeated. However, this process involves complex fabrication steps. Thus, when the positive-type resist is to be removed in the PEP step in the above-described Examples, the photomask, which is so designed as to vary the film thickness of the positive-type resist, is used. Using O₂ ashing, etc., the removal of the first to third pattern sections and the patterning of the electrically conductive film or insulation film are performed at the same time. Thereby, without increasing the number of fabrication steps, the first insulation parts 12a, second insulation parts 12b and third insulation parts 12c and the pixel electrodes 27a, 27b and 27c having desired thicknesses can be obtained by the simple method.

The present invention is not limited to the above-described embodiments, and various modifications can be made within the scope of the invention. For example, the light-transmissive inorganic parts 8 and the other light-transmissive inorganic parts 9 are formed of the first undercoat insulation film 12 and pixel electrodes 27a, 27b and 27c. Alternatively, these light-transmissive inorganic parts may be formed of the SiO_{X}-based second undercoat insulation film 13 or the common electrode 41. To be more specific, no problem arises if at least one of the first undercoat insulation film 12, second undercoat insulation film 13, pixel electrodes 27a, 27b and 27c and common electrode 41 is formed as the light-transmissive inorganic part.

The gate insulation film and the interlayer insulation film are films which affect the characteristics of the TFTs 14 and the product reliability. If the thicknesses of these films are partly varied, the uniformity in display characteristics and the reliability may deteriorate.

The display mode of the liquid crystal display device is not limited to the TN mode, and may be a VA (Vertically Aligned) mode or an OCB (Optically Compensated Birefringence) mode. In addition, the color filter 4 may be provided on the array substrate 1 or the counter-substrate 2.

In order to vary the film thicknesses of, for instance, the pixel electrodes 27a, 27b and 27c functioning as the light-transmissive inorganic parts, it is possible to radiate ultraviolet ray to the electrically conductive film by using exposure masks with different meshes.

What is claimed is:

1. A liquid crystal display device comprising:
an array substrate including a base plate;
a counter-substrate which is arranged opposite to the array substrate with a gap therebetween;
a plurality of first pixel sections and a plurality of second pixel sections, which are provided between the array substrate and the counter-substrate;
a liquid crystal layer which is held between the array substrate and the counter-substrate;
a color filter which is provided on the array substrate and includes a plurality of first color layers, which form the first pixel sections, and a plurality of second color layers which form the second pixel sections and have a color different from a color of the first color layers; and
an undercoat insulation film which is provided on a surface of the base plate and includes a plurality of first light-transmissive inorganic parts, which form the first pixel sections and are set at such a film thickness that a wavelength at which a transmittance spectrum of the first pixel sections increases agrees with a wavelength at which a transmittance spectrum of the first color layers increases, and a plurality of second light-transmissive inorganic parts which form the second pixel sections and are set at such a film thickness that a wavelength at which a transmittance spectrum of the second pixel sections increases agrees with a wavelength at which a transmittance spectrum of the second color layers increases.

2. A liquid crystal display device comprising:
an array substrate including a base plate;
a counter-substrate which is arranged opposite to the array substrate with a gap therebetween;
a plurality of first pixel sections and a plurality of second pixel sections, which are provided between the array substrate and the counter-substrate;
a liquid crystal layer which is held between the array substrate and the counter-substrate;
a color filter which is provided on the counter-substrate and includes a plurality of first color layers, which form the first pixel sections, and a plurality of second color layers which form the second pixel sections and have a color different from a color of the first color layers; and
an undercoat insulation film which is provided on a surface of the base plate and includes a plurality of first light-transmissive inorganic parts, which form the first pixel sections and are set at such a film thickness that a wavelength at which a transmittance spectrum of the first pixel sections increases agrees with a wavelength at which a transmittance spectrum of the first color layers increases, and a plurality of second light-transmissive inorganic parts which form the second pixel sections and are set at such a film thickness that a wavelength at which a transmittance spectrum of the second pixel sections increases agrees with a wavelength at which a transmittance spectrum of the second color layers increases.

3. The liquid crystal display device according to claim 1, wherein a film thickness of the first light-transmissive inorganic parts is different from a film thickness of the second light-transmissive inorganic parts.

4. The liquid crystal display device according to claim 2, wherein a film thickness of the first light-transmissive inorganic parts is different from a film thickness of the second light-transmissive inorganic parts.

5. The liquid crystal display device according to claim 1, further comprising a plurality of pixel electrodes which are provided on the base plate in a matrix and include a plurality of other first light-transmissive inorganic parts, which form the first pixel sections and are set at such a film thickness that a wavelength at which a transmittance spectrum of the first pixel sections increases agrees with a wavelength at which a transmittance spectrum of the first color layers increases, and a plurality of other second light-transmissive inorganic parts which form the second pixel sections and are set at such a film thickness that a wavelength at which a transmittance spectrum of the second pixel sections increases agrees with a wavelength at which a transmittance spectrum of the second color layers increases.

6. The liquid crystal display device according to claim 2, further comprising a plurality of pixel electrodes which are provided on the base plate in a matrix and include a plurality of other first light-transmissive inorganic parts, which form the first pixel sections and are set at such a film thickness that a wavelength at which a transmittance spectrum of the first pixel sections increases agrees with a wavelength at which a transmittance spectrum of the first color layers increases, and a plurality of other second light-transmissive inorganic parts which form the second pixel sections and are set at such a film thickness that a wavelength at which a transmittance spectrum of the second pixel sections increases agrees with a wavelength at which a transmittance spectrum of the second color layers increases.

7. The liquid crystal display device according to claim 1, wherein the counter-substrate includes another base plate and a common electrode which is provided on said another base plate and includes a plurality of other first light-transmissive inorganic parts, which form the first pixel sections and are set at such a film thickness that a wavelength at which a transmittance spectrum of the first pixel sections increases agrees with a wavelength at which a transmittance spectrum of the first color layers increases, and a plurality of other second light-transmissive inorganic parts which form the second pixel sections and are set at such a film thickness that a wavelength at which a transmittance spectrum of the second pixel sections increases agrees with a wavelength at which a transmittance spectrum of the second color layers increases.

8. The liquid crystal display device according to claim 2, wherein the counter-substrate includes another base plate and a common electrode which is provided on said another base plate and includes a plurality of other first light-transmissive inorganic parts, which form the first pixel sections and are set at such a film thickness that a wavelength at which a transmittance spectrum of the first pixel sections increases agrees with a wavelength at which a transmittance spectrum of the first color layers increases, and a plurality of other second light-transmissive inorganic parts which form the second pixel sections and are set at such a film thickness that a wavelength at which a transmittance spectrum of the second pixel sections increases agrees with a wavelength at which a transmittance spectrum of the second color layers increases.

9. The liquid crystal display device according to claim 1, wherein the undercoat insulation film is formed of an SiN_{X}-based material or an SiO_{X}-based material.

10. The liquid crystal display device according to claim 2, wherein the undercoat insulation film is formed of an SiN_{X}-based material or an SiO_{X}-based material.

11. The liquid crystal display device according to claim 1, wherein the array substrate comprises a plurality of signal lines which are disposed on the base plate, a plurality of scanning lines which are so disposed on the base plate as to cross the signal lines, and a plurality of switching elements which are provided near intersections between the signal lines and the scanning lines and are disposed on the base plate, and
the color filter is formed on the base plate, the signal lines, the scanning lines and the switching elements.

12. The liquid crystal display device according to claim 1, wherein a film thickness of the first light-transmissive inorganic parts and a film thickness of the second light-transmissive inorganic parts are in a range of 10 to 1000 nm.

13. The liquid crystal display device according to claim 2, wherein a film thickness of the first light-transmissive inorganic parts and a film thickness of the second light-transmissive inorganic parts are in a range of 10 to 1000 nm.

14. The liquid crystal display device according to claim 5, wherein a film thickness of said other first light-transmissive inorganic parts and a film thickness of said other second light-transmissive inorganic parts are in a range of 10 to 1000 nm.

15. The liquid crystal display device according to claim 6, wherein a film thickness of said other first light-transmissive inorganic parts and a film thickness of said other second light-transmissive inorganic parts are in a range of 10 to 1000 nm.

16. The liquid crystal display device according to claim 7, wherein a film thickness of said other first light-transmissive inorganic parts and a film thickness of said other second light-transmissive inorganic parts are in a range of 10 to 1000 nm.

17. The liquid crystal display device according to claim 8, wherein a film thickness of said other first light-transmissive inorganic parts and a film thickness of said other second light-transmissive inorganic parts are in a range of 10 to 1000 nm.

18. The liquid crystal display device according to claim 1, further comprising a plurality of third pixel sections which are provided between the array substrate and the counter-substrate,
wherein the color filter is provided on the array substrate and includes a plurality of third color layers which form the third pixel sections and have a color different from the colors of the first color layers and the second color layers, and
the undercoat insulation film is provided on the surface of the base plate and includes a plurality of third light-transmissive inorganic parts which form the third pixel sections and are set at such a film thickness that a wavelength at which a transmittance spectrum of the third pixel sections increases agrees with a wavelength at which a transmittance spectrum of the third color layers increases.

19. The liquid crystal display device according to claim 2, further comprising a plurality of third pixel sections which are provided between the array substrate and the counter-substrate,
wherein the color filter is provided on the counter-substrate and includes a plurality of third color layers which form the third pixel sections and have a color different from the colors of the first color layers and the second color layers, and
the undercoat insulation film is provided on the surface of the base plate and includes a plurality of third light-transmissive inorganic parts which form the third pixel sections and are set at such a film thickness that a wavelength at which a transmittance spectrum of the third pixel sections increases agrees with a wavelength at which a transmittance spectrum of the third color layers increases.

20. The liquid crystal display device according to claim 18, wherein the first color layers, the second color layers and the third color layers are color layers which are selected from red color layers, green color layers and blue color layers, and the first to third color layers are different from each other in color.

21. The liquid crystal display device according to claim 19, wherein the first color layers, the second color layers and the third color layers are color layers which are selected from red color layers, green color layers and blue color layers, and the first to third color layers are different from each other in color.
